(19) United States
(12) Patent Application Publication
(10) Pub. No.: US 2014/0250708 A1
(43) Pub. Date: Sep. 11, 2014

(54) Self-Reading Measuring Device, System and Method

(71) Applicant: Anthony John Bauer, Artarmon NSW (AU)

(72) Inventor: Anthony John Bauer, Artarmon NSW (AU)

(21) Appl. No.: 14/196,783

(22) Filed: Mar. 4, 2014

Related U.S. Application Data
(60) Provisional application No. 61/773,000, filed on Mar. 5, 2013.

(51) Int. Cl. G01B 3/10

(52) U.S. Cl. CPC G01B 3/1061; G01B 2003/1069; G01B 2003/1058
USPC 33/760; 29/428

(57) ABSTRACT

A new or alternate self-reading measuring device that measures length by reading and recording barcodes that are contained in a tape's indicia to enable the calculation of the distance between two positions associated with the indicia.

### TECHNICAL FIELD

The present invention relates to tapes for measuring, and in particular to portable measuring tapes.

The invention has been developed primarily for use as a means for measuring items accurately and transferring said measurements electronically. However, it will be appreciated that the invention is not restricted to this particular use.

### BACKGROUND

It is established practice that to measure an object, users place a measuring tape along an object to record dimensions such as length, width, height or diameter by reading the distance between the most distal end of the tape to the point selected by the operator, which is usually somewhere proximal to the tape's housing.

However, when considering that the goal of the above task is to record one or more dimensions of an object, there has been little consideration as to where the above task fails. The source of most errors in taking measurements resides in either:

1. incorrectly reading the measurement from the ruler/measuring tape; and/or

2. incorrectly transferring the reading using a recording device, such as a pencil and paper.

To achieve accurate, reproducible measurement, the distance between two points must be read and recorded accurately, so that transcription and other errors are minimized. Likewise, the reading and recording of measurements must also be done efficiently so as not to introduce new obstacles in this reading and recording process.

Measurement errors, including observational errors, are commonly made by taking a “measured value”, as incorrectly read from a tape measure so that the “measured value” is erroneous, as opposed to measuring a true length. Measurement error is also compounded with instrument error, which refers to the combined accuracy and precision of the measuring device used.

To remove such errors, the precision of the measuring device can be increased, which consists of:

1. increasing the resolution of the readings obtained, which is difficult with known measuring tapes; and

2. removing or decreasing the risk of misreading the measurements sought.

Tape measures in most settings are accurate to the millimeter resolution. For example, measurements may be taken to confirm that a box can fit through the doorway, or the volume of multiple boxes when stacked can fit into a shipping container. Such measurement of the above object's dimensions, accuracy is important—particularly in circumstances involving multiple measurements in which any inaccuracy can be compounded, resulting in significant and costly errors.

It would be helpful to have a means to reduce measurement error, where instrument error in the form of observational error and/or transcription errors impede proper and effective measurement. Decreasing the risk of misreading a measurement is one means to improve measurement accuracy. Addressing and removing measurement misreading error increases the functionality of the measuring device.

One of the sources of misreading a measuring tape is that users often accurately read one scale correctly, but misread the broader scale:

For example, a misreading may be taken as 5,865 millimeters, instead of a true length 6,865 millimeters, since the fine scale of 865 mm is correctly read; however, the addition of the meter length must be followed back along a tape—this is referred to as “back reading”. To follow the above example, the 6 meter marking may be missed, so the 5 meter mark is read and recorded. This results in major errors due to the user not being able to read the measurement directly.

Further, transcription errors create obstacles for accurate, reproducible measurements being received. This is especially true when measuring more than one dimension on an object—such as height, length and breadth—or multiple objects, when length, width and height all need to be transcribed to a recording device (usually a pen and paper). Here, the error is compounded, since the readings and transcriptions are sources of error.

Even when objects are measured and transcribed accurately, measurement recording fails, since the association of a measurement with specific dimensions (height, length, width) are often confused. This is critical in logistics where a dimension may have a vectorial constraint, such as when particular items must be transported standing upright.

Readings taken from measuring tapes are also dependent on the eyesight of the reader and therefore must be conveyed in a clear manner. However, the higher the precision of the measuring tape, the lower the resolution of the display of the measurement indicia.

For example, the meter length is often left off the tape measure markings except at meter intervals; likewise, the numbers showing the hundred millimeter interval—100 mm, 200 mm, 300 mm . . . —are only shown every hundred millimeter and so on. This makes reading a tape accurately a difficult task for those with challenged eyesight.

Therefore, on reading a measuring tape, the accuracy of the millimeter readings as shown via indicia markings (for example, 86 mm) is difficult. The reader has to “back read” along the tape to the nearest hundred millimeters (to read, say to a measurement of 500 mm), and then travel further back along the tape to get the meter reading (such as 6 m). The calculation is then performed to measure distance of 6,586 mm. If this was a height measurement or a measurement where movement is restricted, then performing these measurements can be very difficult.

The error in backtracking or “back reading” along a tape to get to the nearest hundred millimeter mark or meter mark also induces error, since the calculation to put the associated interval measurements together, takes human involvement.

“Back reading” along a tape measuring tape is particularly problematic for those who have no inherent conceptualization of length, including those who suffer from conditions such as micropsia (a disorder where a user's visual perception perceives objects to be closer and therefore smaller than they actually are) and macropasia (where visual perception distortions exist, so that objects are perceived as larger than their true size).

Such perception errors (along with measurement error) create difficulties in taking measurements where there is no innate or internal reference point for the user (such that the familiarity with the distance being measured). Thus the “back reading” for the gross measurement often gets misread, say, 5 m gets misread for 4 m due to the 5 m indicia being missed. The impact of such errors is severe.

Unfortunately, to overcome this problem with known measuring tapes, indicia on the measuring tape are often compacted together so that, say, meter measurements can simultaneously be read with the finer millimeter measurements. This solution results in the resolution of the measuring tape and/or the indicia decreasing. That is, to overcome the former problem, a new problem of poor indicia resolution arises.

A problem, therefore, currently exists with measuring tape being used by:

1. those with limited eyesight;

2. measurements being taken in difficult areas to maneuver within;

3. those who have no inherent perception of length; and/or

4. measurements being taken in poor light.

To overcome one or more of the above difficulties, the following attempts have been made:

U.S. Pat. No. 5,433,014 addressed the problem of reading a measuring tape by placing a series of optical markings at predetermined increments corresponding to a fixed unit of measurement. These markings were read by photoelectric cell when the tape is extended or retracted. The impediment with such a device is that the markings are “counted” as they pass the optical reader. This solution had the obstacle of when the tape is extended or contracted quickly, then the count experienced errors.

Optical readers performing counts of “holes” are only as good at which the speed of the count is executed at—that is, if the speed is too great then the recording of counts becomes inaccurate.

Further still, an optical reading is only accurate when the tape is extended from a fully retracted position which poses a problem if the automated reading must be verified by human reading, which requires the tape measure to be at a static position so the numerical data can be read. Therefore, the above counting method cannot take place with simultaneous verification by a human reading, since the former takes place only when the dynamic extension of the measuring tape takes place, whereas the latter takes place when the measuring tape is statically positioned at its desired extension for human reading. U.S. Pat. No. 5,386,643 and U.S. Pat. No. 5,426,863 utilizes similar counting methods.

US Patent Application No. 2004/0040170 also included an optical sensor to read the rotation of the tape storage spool as length of tape drawn from a storage spool through the opening of a housing to enable measurement.

The problem with this approach is that the diameter of the wound tape changes with the amount of tape wound onto the spool. That is, when the tape is fully wound, then the length of tape released, equivalent to one rotation of the spool, will be greater than the equivalent rotation, when the spool is almost empty of tape (when most the tape has been released). That is one equivalent rotation of the spool does not correspond to a fixed amount of tape released when the spool is full compared to when the spool is empty, when less length of tape is released. Therefore, an optical sensor measuring the rotation of storage spools is not an accurate reflection of the tape released.

U.S. Pat. No. 6,672,510 incorporates a barcode “ribbon” which is placed onto an object requiring measurement. This ribbon is then read by a hand-held barcode scanner. This scanner reads the ribbon's barcodes by aligning the scanner beam to the position on the ribbon to be read.

A scanner is a beam that scans and therefore the resolution by its nature is inaccurate, since the scanner must be held at a distance so the position sought on the ribbon can be seen by the user. This creates a greater scan arc and an increased resolution error. If, conversely, the scanner is held closely to the ribbon, then the exact alignment of the scanner with the position on the ribbon cannot be confirmed, since the scanner is covering the ribbon and therefore occluding the view of the user holding the scanner and blocking the view. This system consequently has problems with obtaining resolution and also requires a separate barcode ribbon and scanner to be utilized. This is very difficult when trying to hold down a barcode “ribbon” at either end in its exact place for measurement and then step away to scan the barcodes at either end.

U.S. patent application Ser. No. 10/997,232 provides a summary of other associated prior art and presents another attempt at overcoming the problems presented with automated reading of distance as measured via a tape measure. Symbol and characters are interlaced within the measuring units, so that a measurement can be read by a separate scanner. Since the symbols are interspaced between the measurement markings, they occlude continuous measurement and limit the resolution of measurement to five millimeters.

U.S. Pat. No. 504,868 incorporates optic fibers into transparent tape so that light when transferred onto an optical detection system provides a digital readout. The requirement for ambient light to be present to enable detection of optic fiber light transmission for a measurement reading to be taken is a limitation.

The risks associated with use of common measuring tapes include:

1. poor resolution of the measurement indicia;

2. indirect reading of the measurement indicia such that different magnitudes of the measurement have to be added together (that is, measured meter distances need to be added to sub distances such as 100 mm and 10 mm);

3. measurement can only be taken in locations of good light, posing a risk to the measurement when taken in poor light;

4. the dimensions for which the measurement is able to be taken are only able to be recorded so long as the measuring tape remains secured at one end while the tape is unwound towards a second point to obtain the measurement. The loosening of the anchoring point allows increasing extraction of the tape, which in turn decreases the resolution of the measurement able to be taken. This creates difficulty in tight spaces where one end of the tape is unable to be anchored;

5. the measuring tape does not facilitate or maintain access to previous measurements except via indirect access to where the measurement was originally taken. Therefore, repetitive measurements are unable to be taken to provide averages so as to decrease observational error.

It would be an advantage to have a measurement device that overcomes one or more of these problems of inaccurate, non-reproducible measurement and also provides an opportunity for removing human error in reading measurements.

It would also be an advantage to have a measurement device that increased the efficiency with the transfer of measurements from the measured object to the recording device. It would be a further advantageous if the vectorial dimensions (e.g. height, width, length etc.) of the measured object could be transferred efficiency with the actual measurements, so as to accurately describe the target measured object's dimensions.

It is an object of the present invention to provide a new or alternative measuring device that overcomes one or more errors associated with known measuring devices.

### SUMMARY OF THE INVENTION

There is provided a self-reading measuring device that does not suffer the disadvantages of using a traditional measuring tape and that effectively measures by precisely recording the distance between two points so as to provide a direct measurement reading. There is further provided a self-reading measuring device that provides for measurement error minimization by increasing measurement accuracy while measuring an object, yet still affording sufficient display of the measurements taken, so as to provide the opportunity for the measurement to be read directly and with ease.

According to one aspect of the invention there is provided a self-reading measuring device, including:

(a) a tape-like elongate body, the body having barcodes placed at predetermined positions, each barcode indicating the barcode's position on the tape-like elongate body,

(b) one or more barcode readers at least one of which is configured to read one or more of the barcodes on the tape-like elongate body,

wherein the distance between a first position and a second position on the tape-like elongate body can be calculated.

This measurement device enables accurate, reproducible measurement, through incorporation of the following elements into the device:

(a) barcodes spaced at specified intervals along a tape-like elongate body, which, in one embodiment, takes the form of a measuring tape, but in other embodiments may take the form of wire, ribbon, tape, thread, or other physical forms, wherein one or more said barcodes along the tape-like elongate body are readable by a barcode reader;

(b) an actuator configured to cause a barcode reader to read a barcode at one or more specified positions on a tape-like elongate body, the barcode containing measurement information and the actuator enabling the reading (retention in memory) of the measurement information so as to record a measurement of a particular distance between two points.

In a further embodiment, the retained measurement information is recorded in memory so that it can subsequently be used within a formula to calculate one or more measurements such as area, volume et cetera;

(c) measurement information as read by said barcode reader is communicated by:

i. being displayed on a display such as liquid crystal display or associated zero or low power displays, active matrix displays, or other display screens depending on requirements of power consumption, readability (including imitation of viewing angle), durability, size et cetera. The display is incorporated in a housing for the measuring device and/or communicated to another display using a nominated protocol and associated apparatus (discussed further below); or

ii communicated via an audio system that reads out the measurement information, so that a user does not need to read the measurement from the device; and

(d) a housing containing said barcode reader in a position to read the barcodes on the extended tape-like elongate body to allow barcodes to be read (in conditions such as poor light),

wherein said housing surrounds said tape-like elongate body so as to allow the:

1. extension of the tape-like elongate body through an opening within said housing; and

2. maintenance of the tape-like elongate body's position relative to the barcode reader, thereby facilitating the reading of one or more barcodes relative to the extraction of said tape-like elongate body from said housing.

The invention provides a new or alternative measurement device, system and method for accurate, reproducible measurement by precisely measuring by reading indicia, such as barcodes (including matrix barcodes) marking and recording the distance between two points as measured by the extraction of tape-like elongate body. This is to reduce measurement error while allowing extraction of the tape to be positioned as with known art, so as to not require additional training.

For a better understanding of the invention and to show how it may be performed, a preferred embodiment will now be described, by way of non-limiting example only, with reference to the accompanying drawings and example.

### DESCRIPTION OF THE DRAWINGS

FIG. 1A shows a perspective version of the measurement device according to a preferred embodiment as adapted from known measuring tapes; and

FIG. 1B shows an elevated view of the measurement device according to one embodiment.

FIG. 2 shows an alternative arrangement of the embodiment shown in FIG. 1.

FIG. 3 shows an alternative embodiment, with the extracted tape-like elongate body showing barcodes on the tape's surface.

### DESCRIPTION OF THE PREFERRED EMBODIMENT

The invention provides a new or alternative measuring device, comprising:

1. an extendable tape-like elongate body along which measurement indicia are recorded at specified intervals using barcodes or other digital format that can be automatically read by a processing means;

2. a reader that reads the barcodes associated with the distance a tape has been extended from the measurement device's housing, relative to one or more external barcode readers.

Preferentially, in other embodiments there are following features:

3. a reader reads digital formatting such as barcodes, where said reader takes the form of a barcode reader;

4. This reading of digital formatting (hereafter barcode which is inclusive of digital formatting) enables processing of the information read by the measuring device so that a measurement is enabled to be calculated by said device, which measurement reflects the length between two points on which the tape-like elongate body is held adjacent with. For example:

(a) the first point of measurement being the end point of the tape; and

(b) the second point of measurement being a chosen reference point such as the point of extraction of the tape from the tape measure's housing;

5. reads, communicates and/or displays the measurement as read from the barcodes; and/or

6. records the measurement as read.

Tape-Like Elongate Body

The tape-like elongate body may take the form of ribbon, wire, tape, or other means such that the tape may be printable and disposable once extended from said housing. The tape may take the form, in further embodiments, to be stickable (reversibly or permanently) onto the surfaces of the article to be measured, so that repeatable measurements can be taken from the same tape at different locations.

Tape Extraction

The tape-like elongate body is extractable from the tape release means contained in the housing; however, the retractable nature of the tape-like elongate body in some embodiments is not restricted to being retracted on a sprung rotatable spool within the measuring device's housing. The retractable nature of the tape-like elongate body is also envisaged to be enabled via a stackable, foldable, concertina, telescopic or other means of compacting the tape-like elongate body so that it is easily extendable and retractable, if and, as desired (one embodiment has the tape in a non-retractable form as discussed further below).

Barcode Location

The reading of one or more measurement points are performed by reading barcodes on the tape-like elongate body that are contained within or adjacent to the measurement indicia, which are also located on the tape-like elongate body.

Measurement indicia located on measuring tapes are known; however, barcodes contained within measurement indicia are not known. In alternate embodiments, barcodes are located among or alongside measurement indicia.

The advantage of having barcodes contained within or among measurement indicia is that readings of “measured length” as conveyed by reading the barcode can be simultaneously confirmed by manually reading the tape. This overcomes the problems introduced by known digital tapes in that the technique for reading the tape was considerably different and consequently not able to provide comfort with adoption of digital tapes, since there was no way to reconcile known practices of using a measuring tape with new digital tape measurement techniques.

Barcode Size

The barcode sequence is placed at specified intervals that include barcodes of a minimum size that are suitable for the scale and resolution selected. Barcodes are printable with lines at the scale of 1/1000″, which enables individual barcodes to fit within a millimeter indicia of a tape-like elongate body and it is common for barcodes to have a dimension of 0.1 millimeters. These barcodes can be measured dynamically or statically at a proximal or distal location with error rates far superior to human readable tapes. For example, in commonly-used commercially available barcodes, the range of barcode accuracy ranges from 1 error in 394 thousand trials (worst-case) to 1 error in 612.9 million trials (best case).

In one embodiment, contained barcodes are able to be interpreted by humans in that they are human readable by having associated letters and numbers.

Barcode Reader

The barcodes contained on the tape-like elongate body are readable by a barcode reader which, in a preferred embodiment, is located at the point at which the tape-like elongate body extends, via an opening, from the tape device's housing.

The location of the barcode reader at this position is to capture barcodes directly adjacent with said opening of the measuring device's housing. This is to utilize the behavior of users who commonly use a tape for measuring by selecting points demarcating the length of the tape by choosing from:

(a) the end point of an extended tape most distal to the measuring device's housing which is also often used as an anchoring point; and

(b) the point of measurement most proximal to the opening of the measuring device's housing where the tape is extruded from.

In this embodiment, the barcode reader will read the point “most proximal to the opening of the measuring device's housing where the tape is extruded from” and state the distance as read being equivalent to the measured length from the tape's distal end to the tape's most proximal end.

However, in other arrangements the tape-like elongate body's barcodes may be read from alternate selected positions. Likewise, in other embodiments and associated arrangements, the barcode reader could be located within the housing of the measuring device, on the outside of the measuring device's housing, or external to the measuring device's housing. Appropriate calculation could then be performed to adjust for the position of barcode reading points so that the “measured length” would reflect the “true length” of an object measured.

Measured Length Display

The reading of one or more barcodes is then displayed on the measuring device's housing and/or displayed on an associated recording device through appropriate transmission protocols.

The reading and display of the selected barcode is to ensure that measurement is displayed clearly. For example, large digits showing 6,586 mm imparts a very specific measurement in our minds. Research indicates that this ability to access such information in a ready form format is important for conceptualization of a dimension.

In a preferred embodiment, the tape-like elongate body has:

1. precision in measuring distances selectable to meet the resolution required;

2. measurements are read by the barcode reader directly from the barcode at one or more selectable and specified positions on the tape-like elongate body, as opposed to “back reading” along the tape requiring the addition of different measurements together (that is, adding the “gross” meter length to the “fine” millimeters length measured); and

3. have one or more measurements (or their resultant calculations) shown in large readable type displaying the measurement taken (via reading the barcode) on the surface of the housing, which is able to be illuminated if required.

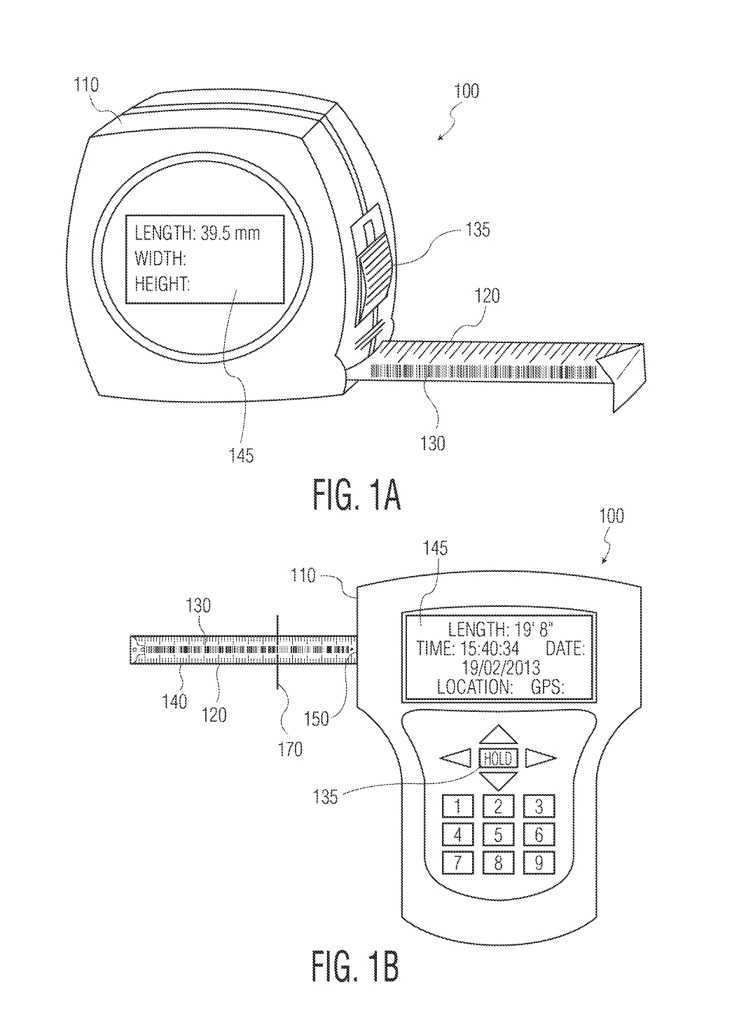

FIG. 1A shows a display of a barcode reading taken from a barcode on the tape-like elongate body 120 at the point of extension from the mouth of the housing 110. This display 145 reveals a nominated “length” reading. With further extension of the tape, the display will change to reflect the length of tape extended, as read by the barcode reader enclosed within the housing 110.

FIG. 1B show a similar display 145 of the barcode reading with additional data available for inclusion such as:

1. length in feet and inches as the nominated units of measurement;

2. time and date that the measurement was taken; and

3. location via GPS parameters.

Tape Release Means

The housing in the preferred embodiment encases a tape-like elongate body release means. Such a release means may take several forms, including one or more of the following:

a) a rotating spool upon which a tape-like elongate body is wound. In one embodiment, the spool is spring-loaded so that the tape-like elongate body is retractably biased when extended, so that the tape-like elongate body is returned and enclosed by said housing;

b) a cartridge upon which a tape-like elongate body is enclosed, wherein in one embodiment, the cartridge is reversibly biased so that the tape-like elongate body is automatically retractable once released, so that the tape-like elongate body is returned and enclosed by said housing.

The spool and cartridge are examples of several alternative release means to provide a means for selectively causing the tape-like elongate body to be releasable, extendable and, in some embodiments, retractable to be contained within said housing. The tape-like elongate body insertion and removability also provides for tape replacement and tape interchange so selection of tapes for different needs and environments can be enabled.

In practice, said tape-like elongate body is contained within said release means and anchored at one end to said release means and said tape-like elongate body's other end emerges from said housing to be drawn out at a distance suitable for measurement.

Tape and Barcode Joins

In a further embodiment, each tape-like elongate body is enabled to have a unique barcode sequence. This enables one or more tapes to be adhered to a surface so that:

a) tapes are able to be joined and a summation specified by the user, so that extended tape-like elongate bodies are able to be read by a scanner reading distances for which the tape conveys information as to whether one or more tapes are involved in measuring a specified distance; or

b) individual tapes are able to be delegated to specific vectorial locations or dimensions. For example, one tape may have additional information embedded within the barcode specifying that this is a height dimension, whilst another is allocated to mark width, whilst a further tape allocated to measure depth.

Such tape-like elongate bodies are enabled to measure exact dimensions without being restricted to linear measurements, since surface curvature can be taken into account. This enables calculations, such as estimates to lay carpets on undulating surfaces such as stairs or to paint non-linear surfaces, to be performed accurately.

Extended Use

In a preferred embodiment, the reading of barcodes directly provides an advantage over “back reading” as discussed above:

A measuring tape has traditionally being a tool of trade, which means that over time as the tool is used there is dust and damage impacting on the readability of the surface of the measuring tape.

In a situation where a barcode becomes occluded from being read, then the adjacent barcodes may be read, followed by a calculation being performed, to extrapolate what the misread barcode would convey. For example, if in a sequence of barcodes there is a missing barcode, then the missing part to a sequence can be extrapolated. This functionality is included in the calculation and programming apparatus contained in the measuring device's housing.

Programming Features

The self-reading measuring device (hereafter referred to as a measuring device) is enabled to record barcode readings, and when required, perform functions and calculations using the barcode readings. In the preferred embodiment, the measuring device's housing has enclosed an appropriate power supply, memory, storage and programming apparatus such as a System on Chip to provide functionality to perform and communicate such calculations to a display screen.

Communication

The measurements and/or their subsequent calculations are enabled to be communicated using communication protocols and associated apparatus including Bluetooth, near-field communication, Wi-Fi, TCP/IP, USB, flashcard or other means used to communicate information as read by the barcode reader.

Calculations

The functionality of performing tasks such as the calculation of areas, recording the vectorial dimensions in space and/or adjusting measurements, where calculations take place, also enables significant figures to be adjusted to account for compounding errors.

Adjustments

Likewise, in other embodiments, adjustments to the barcode displays and/or communications can be made where variables influence “measured length” compared to “true length”. Such variables may include temperature, pressure and other influences which influence the expansion or contraction of said tape-like elongate body.

Information variables such as temperature and pressure can be received, via communications using the protocols and apparatus mentioned above, by said programming apparatus in said measuring device's housing, or conversely, measurement of temperature and pressure in the local environment can be recorded directly.

This “measurement adjustment” enables measurements to be taken in extreme environments where laser measuring devices fail, such as underwater or at extreme locations such as at the icecaps. Under such conditions, the housing would be sealed to enable measurements to be taken in adverse conditions and appropriate power supply would be incorporated into said housing.

Measuring made in an accurate, reproducible manner by said measurement device is now described as a preferred embodiment.

Referring to FIG. 1A, a view is shown of a preferred embodiment of the self-reading measuring device 100. The self-reading measuring device 100 includes:

1. housing 110 for extraction of the tape-like elongate body 120 from, and to position the barcode reader (not shown as an external bar code reader is contained within the extraction point of the tape-like elongate body 120 from the housing 110) so that one or more barcodes 130 on said tape are enabled to be read proximal to the opening where the tape-like elongate body is extracted from said housing; and

2. a tape-like elongate body 120 containing barcodes 130 in a sequence at specific intervals along said tape (the barcodes are enabled be placed in a continuous manner along said tape-like elongate body 120; however, they are also enabled to be so small so as not to be readily discernible by the eye. Likewise, they may also be printed on the reverse side to the tape since having human reviewable tape indicia is advantageous for comfort and a second point to confirm reading(s)).

The housing 110 includes a tape-like elongate body 120 for extracting from said housing. On one side of the tape-like elongate body 120 is a barcode sequence placed at specified intervals 140 (as shown on FIG. 1B) equally placed along said tape-like elongate body 120.

The barcodes in FIG. 1A are spaced continuously, whilst in FIG. 1B they are space at large intervals apart for exemplary reasons; however, in practice the incidence of barcodes per unit length is dependent on the resolution required of the measurement device.

In this way, the barcode sequence placed at specified intervals 140 forms a distance of consecutive intervals marking portions along said tape-like elongate body 120 seen in FIG. 1A. These barcodes are read by barcode reader (not shown due to located externally) at the most proximal portion of said barcode 130 to said opening of said housing 110.

Referring to FIG. 1B, the barcode sequence is placed at specified intervals 140 to act as a position-marking means to locate the distance between two points by the tape-like elongate body. The first point being the tape-like elongate body's most distal end as extracted from said housing, and the second point being the barcode in position most proximal to the tape-like elongate body's opening by virtue of the following:

1. each barcode positioned most proximal to said opening is designed to be read by said barcode reader, so as to read the barcode for which the measurement is able to be taken; and

2. the barcode is placed at specified intervals 140 accurately reflects the measurement tape's extraction thereby maintaining the tape-like elongate body's measured distance via the barcode's position most proximal to the barcode reader.

In one arrangement of the preferred embodiment, the barcode sequence as placed at specified intervals so as to be read by barcode reader by reading the one barcode most proximal and adjacent to the tape-like elongate body extraction point from said housing. This extraction point is referred to as the housing's opening or mouth.

A specific example is provided below.

### Example 1

This example involves the self-reading measuring device to be held so that one or more barcodes are read by a barcode reader at user nominated selectable points, so as to measure the distance between the selected points.

Using the embodiment 100 illustrated in FIGS. 1A and 1B:

1. @#Extend the tape-like elongate body from the opening of the housing, so that the selected points of measurement are readable by the barcode reader at points where the “tape extraction stop” has been actuated;

2. The barcode reader reads the barcodes at actuated points so the dimension for which the measurement is selectable, calculated and displayed on a display 145 as communicated from the barcode reader. For example, the calculated dimension will in one embodiment will be displayed 145 on the measuring device's housing 110.

In another arrangement, there is more than one barcode read, such that confirmation of the reading of the barcode most proximal to the housing opening to extend the tape through, is verified by reading barcodes exterior and interior to said mouth. The calculation of the average of these barcodes is taken and compared to the barcode most proximal and exterior to said mouth such that a confirmation can be calculated to verify that the barcode readings are accurate and with an expected tolerance.

In a further arrangement, there is more than one barcode reading taken per unit of time by the barcode reader, such that confirmation of the reading of the barcode most proximal to the housing's opening is read by the barcode reader as the tape-like elongate body passes through said opening whilst another reading is taken pre-passing through said open. This enables the verification of the barcode reading(s) by reading more than one barcode, as to overcome a single point of failure (such as one barcode being misread or unable to be read due dust, damage et cetera. The barcode reading is then confirmed as correct at the position at the opening of housing or at some other position so specified (such as at the midpoint of the housing or even at the most right hand side of said housing, so that true measurements can be taken within an interior surface average where the housing may take up a proportion of the length to be measured). These barcode readings are taken and compared to the barcode reading most proximal to said housing's opening such that a confirmation can be calculated to verify that the barcode readings are accurate and with an expected resolution and tolerance.

These calculations verify the “measured length” for which the measurement is taken as being true. This calculation also maintains the tape-like elongate body's functionality in reading many proximal barcodes, so that when measurements are taken in adverse conditions, such as in smoky or dusty environments, where one barcode is unable to be read, then calculations can be made to read barcodes with nearby association to the unreadable barcode, so as to maintain the functionality of the device.

In some arrangements, the barcode sequence to be measured may take place at specified intervals 140 away from the housing's mouth. This is to take into account situations where the measured length may be in a tight situation such that the housing is too large to be held adjacent to the position to be measured. Here, the barcode reader, in a further arrangement, is located at housing's mouth 150, but is configured to read at a set distance exterior to said barcode reader.

For example, FIG. 1B shows a barcode reader set to read barcodes on the axis 170 set at 62 mm along said tape 120 exterior to said barcode reader positioned at said housing's mouth 150.

The calculation of “measured length” to be reconciled with “true length” here is enabled to be achieved by calculating the additional extraction of tape and removing this from the “measured length”. Alternatively, the barcode(s) at a location distal to the housing's mouth may be selected for reading.

The self-reading measuring device 100 facilitates reading barcodes relative to the extraction of said tape-like elongate body from said spool (or retraction alternative) by the barcode that corresponds to the measured length in the following ways:

1. the self-reading measuring device 100 makes the reading of the tape-like elongate body's barcodes proximal to the opening of said housing by retaining the position of the extracted tape relative to the barcode's “measured length” value and allowing for “measured length” to be added or subtracted, so as allow for measurement of positions that do not directly relate to the points of measurement earlier described as:

i. the point at the end of the tape most distal to the housing, and/or

ii. the point on the tape most proximal to the tape's housing's mouth when the tape is extracted from said housing; and

2. the tape-like elongate body is configured so that it is able to be positioned so that when a tape is bent or curved along the surface outside of the sight of a user, then the barcodes can be read such that the length of the missing tape can be calculated. This is useful in situations where a tape may be used to calculate a cavity, such as a Q shape, where on the horizontal surface on the Q is the only part of the tape that can be seen. Here the barcode reader can read the sequences along the horizontal surface and then calculate the gap missing from the sequence (due to the tape being out of view) so as to extrapolate the “measured length” of the non-viewable tape, thereby calculating the curvature length of the non-viewable surface.

By allowing the measurement to be read at selected points along the tape-like elongate body by moving one or more barcode readers along the tape and calculating missing barcode sequences, the self-reading measuring device is enabled to measure non-linear and inaccessible lengths such as the curve of a Q as described above. For example, the curve of the Q may be unseen due to the tape being placed to measure an internal circumference of a hole, as measured by passing the tape into the hole so that only the horizontal regions of the tape positioned into the shape of a Q can be read. This functionality is unable to be performed by laser technologies.

Known measuring tapes also have difficulty with taking such readings, because of the “back reading” problem, where in reading a traditional measuring tape, the addition of different measurements together (that is, the “gross” meter length is located by “back reading” from the immediate “fine” millimeters length measured, then the gross and fine measurements are added together). If part of the measuring tape is “out of sight” then such “back reading” is not possible since part of the tape is out of view.

The self-reading measuring device 100 overcomes the problem of prior art measuring tapes that do not enable the reading of the measuring tape when gross and/or fine measurements are not viewable.

A further advantage of the self-reading measuring device is that readings are retained for the dimensions for which the measurement is taken.

In FIG. 1A and FIG. 1B, the measuring device's housing 110 of the self-reading measuring device 100 includes a “tape extraction stop” 135 (hereafter referred to as a “stop” or “Hold” 135 as shown on FIG. 1B) for holding the measurement tape in a fixed position to enable one or more barcodes to be read. This “stop” is actuated by placing pressure on the front surface of the measuring device's housing via a button or via a grasp, such that a measurement can be taken when required.

An actuator may also be activated when the “tape extraction stop” 135 is pressed. The actuator also enables recording of the associated barcode reader to read said barcode(s) and retain said reading, so that when the tape-like elongate body's extraction is stopped by the actuator, then the barcode is read and recorded for future reference or alternatively to be cleared and discarded by the user utilizing appropriate inputs as received by the program apparatus.

In a still further embodiment of the self-reading measuring device 100, the housing contains a means for dimension (for example, length, breadth, height) nomination functionality such that measurements can be nominated to coincide with a particular dimension independently or consecutively. This enables the recording of independent and dependent dimensions. Consequently, width, height and depth can be recorded independently or simultaneously by positioning the tape-like elongate body in particular vectorial planes. The positioning may be recorded manually and/or automatically confirming by calculating, via a programmatic level, the horizontal, vertical or relative width positioning.

For example, in measuring the dimensions of a box, a sequence of dependent readings may be taken, for which the first reading is nominated to be height, the second reading is nominated to be length, and the third to be nominated as width. In use, the length of an object would be measured with the user pressing the stop actuator to record height, then the length would be measured with the user again pressing the stop actuator to record length, and finally the third dimension of which would be measured and recorded by the width being measured with the user pressing the stop actuator to record width. The volume would then be calculated from these measurements.

Likewise, dimensions can be independently nominated with the appropriate programming functionality. For example, if the stop actuator is pressed twice, then the measured length is recorded as height, alternatively if a stop actuator is pressed three times, then the dimension of width is recorded. Naturally, if the actuator is only pressed once, then the dimension of length is recorded.

This multi-dimension embodiment provides a portable means to measure volume and communicate such volumes dynamically via a single device. This also overcomes problems of measuring objects of a non-rectangular shape, such as spheres and ovoid shaped objects. With a spherically shaped object, an outer (or alternatively inner) circumference can be taken, with the dimension nominated as an outer circumference of a sphere, by pushing the actuator four times, so that an equivalent volume can be calculated. This volume, in specific situations, can be extrapolated to provide an equivalent rectilinear volume, to provide appropriate costing for the logistics such as for calculating shipping costs. This is to ensure an even, accurate fit of the measured volume for transport as measured and calculated by the self-reading measuring device 100.

Thus the self-reading measuring device 100 captures the vectorial dimensions for which the measurement is taken with the tape-like elongate body's barcodes. The device 100 also enables review of dimensions as collected and calculated. For example, if dimensions were incorrectly nominated as having height taken twice and width taken once, but no length recorded, then the volume would not be calculated. On review, one of the height measurements may be reallocated as a width dimension, so the volume can subsequently be calculated. This instills efficiency in maintaining a quality standard by notifying when a potential error has occurred. Measurements are enabled to be reviewed and, if required, reallocated to a different dimensional vectorial plane, or conversely, the dimensions can be re-recorded, compared and reallocated if so desired.

Insertable Tape

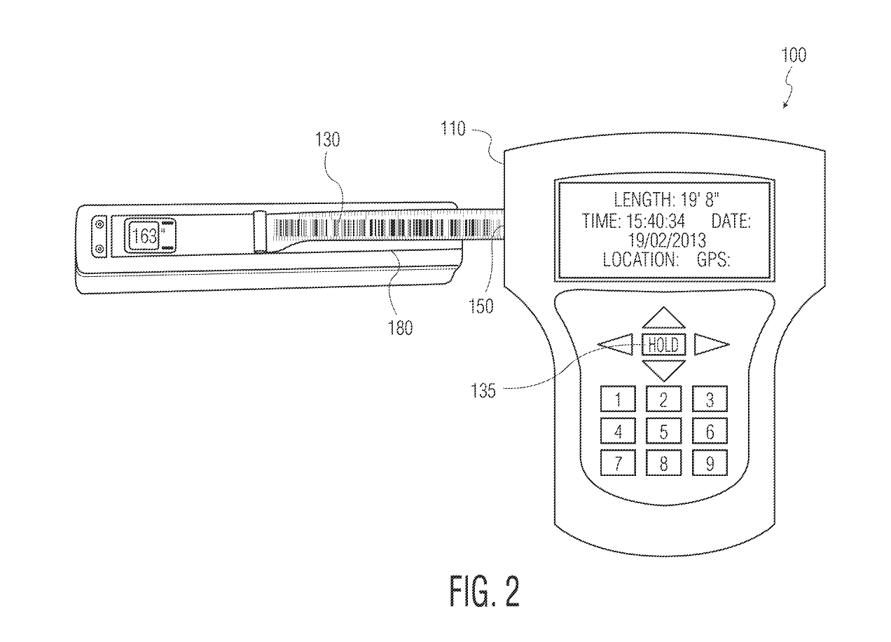

In another further embodiment, the self-reading measuring device 100 shown in FIGS. 1 to 3 is made of a resilient material which is enabled have barcodes printed. The tape can be extendable and attachable to the surface that requires measurement. Once the measurement is taken, the actuator snips the tape so that it is detachable from said housing. This tape as attached (reversibly or non-reversible as selected) to the surface of the object requiring measurement, enables subsequent measurements to be taken by reading the tape by independent hand-held barcode scanners. The advantage of this functionality is that barcode tape is enabled to have additional codes other than just measurement barcodes embedded within the tape, so that logistics barcoding and measurement a combined in the one device.

In one arrangement of this embodiment, the tape-like elongate body is extruded from the housing so that each time the tape is snipped, the tape will be nominated as having a new endpoint (that is the point at which the tape is snipped) so that measurements between the endpoint and the near point of the tape takes into account both the endpoint and near points as dynamically allocated. Here, the tape-like elongate body takes on qualities similar to wrapping tape, Sellotape and logistics' auditing functions.

The tape-like elongate body can be made using any material suitable for containing barcodes, so long as the tape with barcodes has suitable qualities and resolution so that a measurement is able to be taken with “measured length” reflecting “true length”.

The self-reading measuring device 100 has an opening (not shown) to allow insertion and/or replacement of a tape-like elongate body into the housing 110. The tape-like elongate body may be in the form of a spool, cartridge or other form to be insertable into said housing. The opening is closeable by any suitable closure means. In the preferred embodiment, the opening extends along the self-reading measuring device 100, from the housing to the opening so that the inserted tape can be aligned in preparation for extraction from said housing.

In a further still embodiment, the ability to have disposable and/or exchangeable tape enables tape to be selected as being most suitable for the measuring conditions required. That is, specific logistics codes can be printed as the tape is extracted simultaneously whilst measurements are taken.

Additionally, as a tape becomes damaged due to dust and/or use, new tapes are enabled to be inserted. Furthermore, tapes for measuring greater distances can be inserted as can tapes with lower resolution (when large distances need to be calculated, resolution at fractions is the millimeter may not be required). Likewise tapes can be selected for specific environments. For example, an environment may be selected as being highly corrosive, at high oxidation (therefore occluding some metals), high temperature and/or requiring high flexibility.

In yet another embodiment, the self-reading measuring device 100 comprises a panel, which is configured to open to allow insertion of a tape, which then can be subsequently closed to cover the tape-like elongate body enclosed within the housing.

Referring to FIG. 1B, an alternative arrangement of the embodiment illustrated in FIG. 1A is shown, in which the self-reading measuring device 100 has barcode reader 150 that is slideably engageable along the tape-like elongate body, so that it can read at selected stops. It can be seen by comparing FIGS. 1A and 1B that the barcode reader 150 may be positioned to measure between two or more selected points along the tape. The embodiment of FIG. 1B otherwise retains the same features as the embodiment depicted in FIG. 1A.

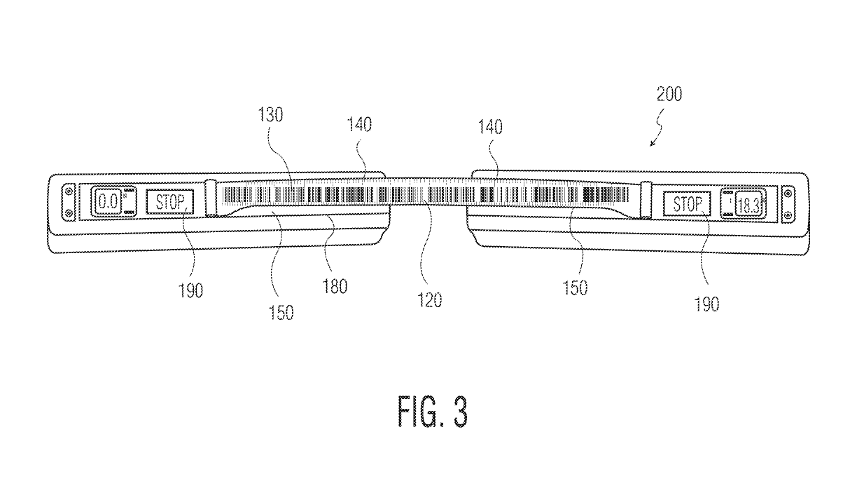

Referring to FIG. 3, an alternative embodiment 200 is shown in which a plurality of barcode readers 150 are placed at specified intervals 140 along the tape-like elongate body 120 to read the barcodes 130. FIG. 3 shows the tape-like elongate body with barcodes 130 read by the barcode reader selectively proximal or re-attached to the tape-like elongate body 120 at a specified barcode intervals 140. The extended tape is enabled to have the barcode reader fastened to the tape-like elongate body using any fastening means.

Referring to FIG. 3, this, a third embodiment 200 contains a300 is shown, in which the position-marking means that retains the tape-like elongate body's position with specified barcodes near the barcode reader includes:

1. tape-like elongate body with barcodes 140 configured to receive the barcode reader in a selectable position; and

2. barcodes that are read by one or more barcode readers from the underside of the observable tape (the tape shown in FIG. 3 has the barcodes shown on the upper-side of the tape for exemplary purposes; however, in other arrangements, the barcodes are located on the underside of the tape to be read by the barcode reader, whilst the upper-side shows human readable measurement indicia and associated numbers, so independent confirmation by a human can be confirmed); and

3. a “tape extraction stop” 190 to selectively align one or more barcode readers placement at specified intervals 140 and the tape-like elongate body 130.

In this embodiment 200, the tape-like elongate body with barcodes 140 has one or more barcode readers that act like sleeves to read the barcodes on the tape for which the measurement is able to be taken. The ends of the tape-like elongate body with barcodes 140 may be open, allowing the barcode reader to be detachable from said tape's ends. Alternatively, the ends of the tape-like elongate body with barcodes 140 may be closed so that the barcode reader is retained upon the tape with barcodes 140.

In contrast to the embodiments 100 and 200 of FIGS. 1 to 3, the embodiment 200 of FIG. 3 relies on friction to resist the barcode reader sliding from a selected position on the tape-like elongate body. Pressure on the barcode reader “stop” button 190 actuates the barcode reader to read the tape-like elongate body's barcodes.

When more than one tape-like elongate bodies containing barcodes 140 are connected, then greater lengths are able to be measured via the extend tape. This involves the logic in the self-reading measuring device in having one or more barcode readers reading information along one or more tapes that have being added together, so that the barcode sequence is additive. Moreover, the device in having a tape-like elongate body with barcodes is still able to be extended and positioned relative to each other by or more barcode readers through virtue of the friction contained in the “tape extraction stop” 190. The embodiment of FIG. 3 otherwise retains the same features as the embodiment depicted in FIG. 1.

Method of Accurate, Reproducible Measurement Using the Device

The invention provides a new or alternative method of accurate, reproducible measurement using a self-reading measuring device that reduces measurement misreading by facilitating reading of barcodes as selectable on a tape-like elongate body.

An advantage of any of the preferred embodiments is that the self-reading measuring device measures and precisely records the distance between two points, yet allowing the tape-like elongate body with barcodes to be situated and read in non-linear, and even unobservable environments (such as measuring the circumference of cavities with small entries so that the tape is able to be inserted but not the device's housing).

The relative positioning of the tape-like elongate body with the barcode reader facilitates the reading of barcodes relative to tape. In this way, the self-reading measuring device offers advantages over other measuring tapes by providing greater flexibility of measurement.

A further advantage of the preferred embodiments is that the self-reading measuring device facilitates reading barcodes relative to the extraction of said tape-like elongate body without relying on a fixed size measuring tape, since additional tapes can be added or exchanged.

Yet another advantage of the self-reading measuring device is that the dimensions for which the measurement is able to be taken are recorded in a position such as height, width, length, circumference et cetera that enables the calculation of volume or other selectable functions.

A further advantage is the tape can be selected or exchanged for resolution and purpose of intended use. Likewise, the information contained in said barcodes is enabled to have additional information inserted such as logistical information containing detail, for example, as to the intended destination of the measured object.

Additional advantages include the combination of:

1. a retractable tape (with flexibility for measuring very small to very large objects) containing barcodes, so that the barcodes are slidable past an optical scanner, and the optical scanner reads, in turn, the length extension of the tape,

2. the wireless transfer of scanned information,

3. algorithms for adding pertinent pieces of information together (length, breadth and height), and

4. the portability of these integers.

The prior art can measure the external dimensions of a rectangular prism but not:

1. the internal dimensions (e.g. a room or the inside of a cylinder); or

2. the dimensions of an irregular or curved shape; and

3. is not portable.

Another advantage is that even in the absence of good light, the device enables a measurement(s) to be taken using the self-reading measuring device.

The invention provides a self-reading measuring device for accurate, reproducible measurement to assist in aligning “measured length” with “true length” of an object. The self-reading measuring device has been developed primarily for use as a means for accurate, reproducible measurement reading and transfer. However, it will be appreciated that the invention is not restricted to these particular fields of use and that it is not limited to particular embodiments or applications described herein.

1. A self-reading measuring device, including:
a tape-like elongate body, said body comprising barcodes placed at predetermined positions, each barcode indicating the barcode's position on the tape-like elongate body; and
at least one barcode reader configured to read one or more said barcodes on the tape-like elongate body,
wherein the distance between a first position and a second position on the tape-like elongate body can be calculated.

2. A self-reading measuring device according to claim 1 wherein the barcodes act as position-marking means, and the barcode reader can read the tape-like elongate body barcodes at one or more positions for determining the length of the extracted tape-like elongate body.

3. A self-reading measuring device according to claim 1 wherein when the tape-like elongate body is in an extended position, the barcode reader reads one or more barcodes.

4. A self-reading measuring device according to claim 1, wherein said first barcode has a position most proximal to a first barcode reader.

5. A self-reading measuring device according to claim 1, wherein the second barcode is at a distal-most end position of the tape-like elongate body or proximal to a second or further barcode reader, or a position-marking means to mark one or more positions along the tape-like elongate body.

6. A self-reading measuring device according to claim 1, comprising a housing for containing, dispensing and positioning the tape-like elongate body relative to the barcode reader,
wherein one or more specified positions on the tape-like elongate body are enabled to be read by the barcode reader for measurement calculation when the tape-like elongate body is positioned such that a measurement calculation is enabled via the reading of the first and second position on the extended tape-like elongate body which enables a distance to be calculated as a length between the two positions on the tape-like elongate body.

7. A self-reading measuring device according to claim 6, having an opening in said housing to allow extraction of a tape-like elongate body from the housing, wherein the opening is closeable such that the self-reading measuring device's tape-like elongate body is capable of being contained in said self-reading measuring device's housing, and wherein the tape-like elongate body's extraction is positioned at a distance so one or more of said barcodes are read by a barcode reader for measurement calculation.

8. A self-reading measuring device according to claim 2 wherein the position-marking means includes:
a barcode sequence positioned at specified intervals near the device's barcode reader on the tape-like elongate body for receiving a measurement length with a barcode reader in position; and
a tension tape extraction stop to hold the tape-like elongate body near the barcode reader so specific barcodes are readable, such that the measured length is able to be read and recorded.

9. A self-reading measuring device according to claim 7 wherein each barcode is positioned at specified intervals to be read from the tape-like elongate body by one or more barcode readers, wherein the read barcode is recorded and displayed on the device or transmitted for display elsewhere.

10. A self-reading measuring device according to claim 6 comprising a tape releasing means for retracting said tape-like elongate body into said housing.

11. A self-reading measuring device according to claim 6 wherein the housing and tape-like elongate body are continuous.

12. A self-reading measuring device according to claim 2 wherein the barcodes act as a position-marking means, said barcodes indicating vectorial position information including one or more of height, width and depth for reading by the barcode reader at one or more positions and determining the length of the extracted tape-like elongate body.

13. A self-reading measuring device according to claim 1 wherein the extracted tape-like elongate body is printable to enable additional specific information to be contained within the printed barcodes, said additional information including one or more of vectorial position, height, width, depth, and/or destination information for distribution logistics; whereby said barcode reader can read the tape-like elongate body barcodes to calculate the size and/or destination of the extracted tape-like elongate body.

14. A self-reading measuring device according to claim 1 wherein the extracted tape-like elongate body has an adhesive surface enable consistent placement of the extracted tape-like elongate body.

15. A method for manufacturing a measuring device including the steps of:
inserting a tape releasing means containing a tape-like elongate body into an opening of a housing; and
closing the opening in said housing after the tape releasing means has been inserted therein,
wherein the tape-like elongate body can be extended from the housing to enable the measurement of distance between two points at specified positions by reading barcodes relative to the extraction of said tape-like elongate body.
